(19) United States
(12) Patent Application Publication
(10) Pub. No.: US 2005/0209848 A1
(43) Pub. Date: Sep. 22, 2005

(54) Conference support system, record generation method and a computer program product

(75) Inventor: Kouji Ishii, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/924,990

(22) Filed: Aug. 25, 2004

(30) Foreign Application Priority Data
Mar. 22, 2004 (JP) 2004-083464

(51) Int. Cl. G10L 15/00

(52) U.S. Cl. 704/231

(57) ABSTRACT

A conference support system includes a data reception portion for receiving image data of attendants in a conference and voice data, an emotion distinguishing portion for distinguishing emotions of attendants in accordance with the image data, a text data generation portion for generating comment text data that indicate contents of speeches of the attendants in accordance with the voice data, and a record generation portion for generating record data that include contents of a speech of an attendant and emotions of attendants when the speech was made, in accordance with emotion data that indicate a result of distinguishing made by the emotion distinguishing portion and the comment text data.

### BACKGROUND OF THE INVENTION

1. Field of the Invention

The present invention relates to a system and a method for generating a record of a conference.

2. Description of the Prior Art

Conventionally, a method for generating a record or a report of a conference is proposed. By this method, voices of attendants at the conference are recorded, and a voice recognition process is used for generating the record of the conference. For example, Japanese unexamined patent publication No. 2003-66991 discloses a method of converting a speech made by a speaker into text data and assuming an emotion of the speaker in accordance with a speed of the speech, loudness of the voice and a pitch of the speech, so as to generate the record. Thus, it can be detected easily how or in what circumstances the speaker was talking.

However, according to the conventional method, although it is possible to detect an emotion of the speaker by checking the record, it is difficult to know emotions of other attendants who heard the speech. For example, when a speaker expressed his or her decision saying, “This is decided,” emotions of other attendants are not recorded unless a responding speech was made. Therefore, it cannot be detected how the other attendants thought about the decision. In addition, it is difficult to know about an opinion of an attendant who made little speech. Thus, the record obtained by the conventional method cannot provide sufficient information to know details including an atmosphere of a conference and responses of attendants.

### SUMMARY OF THE INVENTION

An object of the present invention is to provide a system and a method for generating a record of a conference that enables knowing an atmosphere of a conference and responses of attendants in more detail.

According to an aspect of the present invention, a conference support system includes an image input portion for entering images of faces of attendants at a conference, an emotion distinguishing portion for distinguishing emotion of each of the attendants in accordance with the entered images, a voice input portion for entering voices of the attendants, a text data generation portion for generating text data that indicate contents of speech made by the attendants in accordance with the entered voices, and a record generation portion for generating a record that includes the contents of speech and the emotion of each of the attendants when the speech was made in accordance with a distinguished result made by the emotion distinguishing portion and the text data generated by the text data generation portion.

In a preferred embodiment of the present invention, the system further includes a subject information storage portion for storing one or more subjects to be discussed in the conference, and a subject distinguishing portion for deciding which subject the speech relates to in accordance with the subject information and the text data. The record generation portion generates a record that includes the subject to which the speech relates in accordance with a distinguished result made by the subject distinguishing portion.

In another preferred embodiment of the present invention, the system further includes a concern distinguishing portion for deciding which subject the attendants are concerned with in accordance with the record. For example, the concern distinguishing portion decides which subject the attendants are concerned with in accordance with statistic of emotions of the attendants when the speech was made for each subject.

In still another preferred embodiment of the present invention, the system further comprises a concern degree distinguishing portion for deciding who is most concerned with the subject among the attendants in accordance with the record. The concern degree distinguishing portion decides who is most concerned with the subject among the attendants in accordance with statistic of emotions of the attendants when the speech about the subject was made.

In still another preferred embodiment of the present invention, the system further comprises a key person distinguishing portion for deciding a key person of the subject in accordance with the record. The key person distinguishing portion decides the key person of the subject in accordance with emotions of the attendants except for a person who made the speech right after the speech about the subject was made.

According to the present invention, a record of a conference can be generated, which enables knowing an atmosphere of a conference and responses of attendants in more detail. It also enables knowing an atmosphere of a conference and responses of attendants in more detail for each subject discussed in the conference.

### BRIEF DESCRIPTION OF THE DRAWINGS

FIG. 1 shows an example of an overall structure of a teleconference system.

FIG. 2 shows an example of a hardware structure of a conference support system.

FIG. 3 shows an example of a functional structure of the conference support system.

FIG. 4 shows an example of a structure of a database management portion.

FIG. 5 shows an example of comment text data.

FIG. 6 shows an example of emotion data.

FIG. 7 shows an example of catalog data.

FIG. 8 shows an example of topic data.

FIGS. 9A and 9B show an example of record data.

FIG. 10 shows an example of a display of an image showing an appearance on the other end and emotion images.

FIG. 11 shows an example of symbols that are used for the emotion images.

FIG. 12 shows an example of a structure of an analysis processing portion.

FIG. 13 shows an example of emotion analysis data on a subject basis.

FIG. 14 shows an example of emotion analysis data on a topic basis.

FIG. 15 is a flowchart for explaining an example of a key man distinguishing process.

FIG. 16 shows changes of emotions of attendants from the company Y during a time period while a certain topic was discussed.

FIG. 17 shows an example of characteristics analysis data.

FIG. 18 shows an example of concern data on an individual basis.

FIG. 19 shows an example of concern data on a topic basis.

FIG. 20 shows an example of a display by overlaying an emotion image and an individual characteristic image on an image that shows the appearance on the other end.

FIG. 21 shows an example of an individual characteristic matrix.

FIG. 22 shows an example of cut phrase data.

FIG. 23 is a flowchart showing an example of a general process of the conference support system.

FIG. 24 is a flowchart for explaining an example of a relaying process of images and voices.

FIG. 25 is a flowchart for explaining an example of a record generation process.

FIG. 26 is a flowchart for explaining an example of an analyzing process.

FIG. 27 shows an example of an overall structure of the conference system.

FIG. 28 shows a functional structure of a terminal device.

### DESCRIPTION OF THE PREFERRED EMBODIMENTS

Hereinafter, the present invention will be explained more in detail with reference to embodiments and drawings.

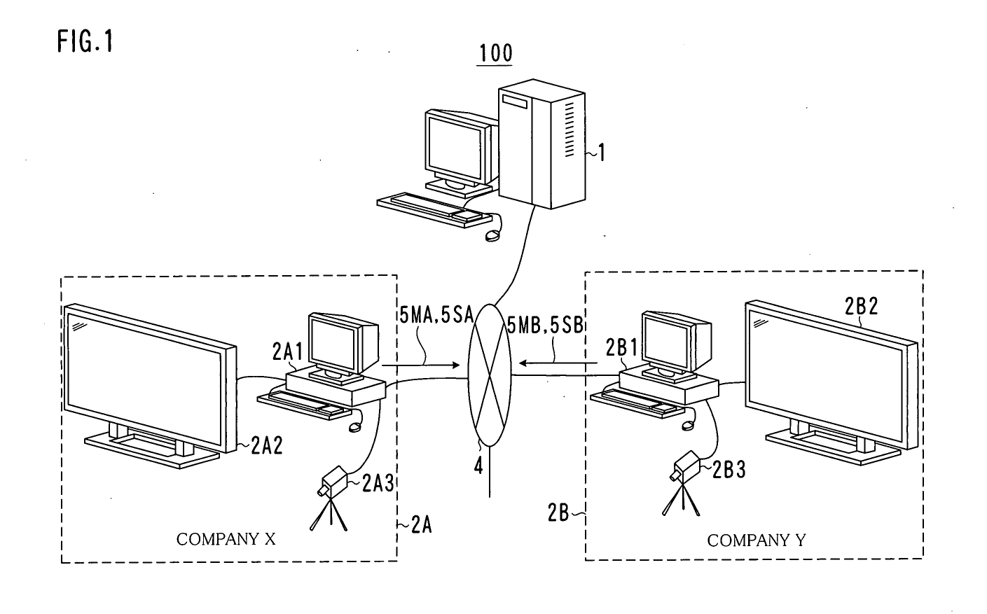

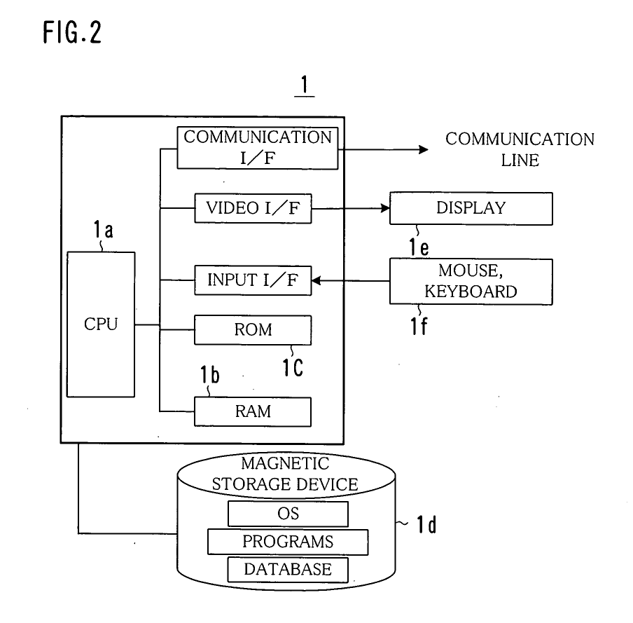

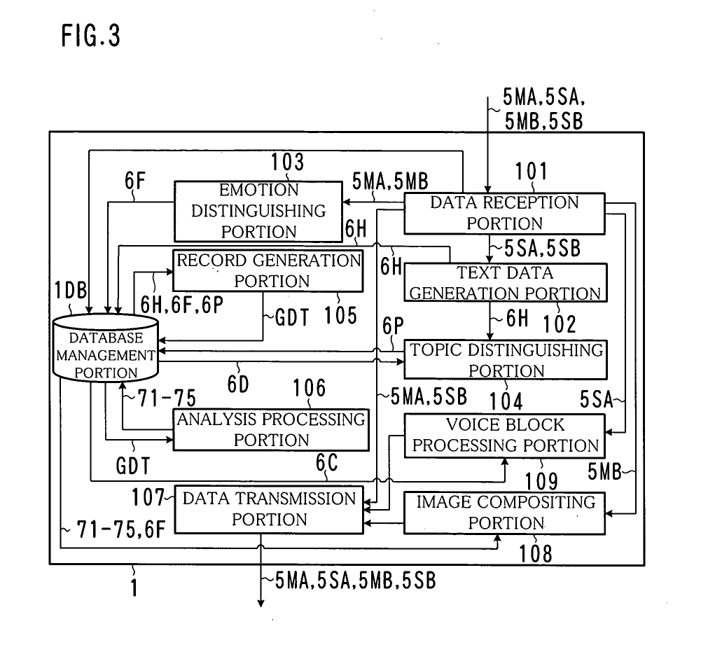

FIG. 1 shows an example of an overall structure of a teleconference system 100, FIG. 2 shows an example of a hardware structure of a conference support system 1, and FIG. 3 shows an example of a functional structure of the conference support system 1.

As shown in FIG. 1, the teleconference system 100 includes a conference support system 1 according to the present invention, terminal systems 2A and 2B, and a network 4. The conference support system 1, the terminal system 2A and the terminal system 2B are connected to each other via the network 4. As the network 4, the Internet, a local area network (LAN), a public telephone network or a private line can be used.

This teleconference system 100 is used for joining a conference in places away from each other. Hereinafter, an example will be explained where the teleconference system 100 is used for the following purpose. (1) A staff of company X wants to do a conference with a staff of company Y who is one of clients of the company X. (2) The staff of the company X wants to obtain information about the progress of the conference and information about attendants from the company Y, so as to carry the conference smoothly and for a reference of a sales activity in the future. (3) The staff of the company X wants to cut (block) a comment that will be offensive to the staff of the company Y.

The terminal system 2A is installed in the company X, while the terminal system 2B is installed in the company Y.

The terminal system 2A includes a terminal device 2A1, a display 2A2 and a video camera 2A3. The display 2A2 and the video camera 2A3 are connected to the terminal device 2A1.

The video camera 2A3 is a digital video camera and is used for taking images of faces of members of the staff of the company X who attend the conference. In addition, the video camera 2A3 is equipped with a microphone for collecting voices of the members of the staff. The image and voice data that were obtained by the video camera 2A3 are sent to the terminal system 2B in the company Y via the terminal device 2A1 and the conference support system 1. If there are many attendants, a plurality of video cameras 2A3 may be used.

Hereinafter, the members of the staff of the company X who attend the conference will be referred to as “attendants from the company X”, while the members of the staff of the company Y who attend the conference will be referred to as “attendants from the company Y.”

The display 2A2 is a large screen display such as a plasma display, which is used for displaying the images of the faces of the attendants from the company Y that were obtained by the video camera 2B3 in the company Y. In addition, the display 2A2 is equipped with a speaker for producing voices of the attendants from the company Y. The image and voice data of the attendants from the company Y are received by the terminal device 2A1. In other words, the terminal device 2A1 is a device for performing transmission and reception of the image and voice data of both sides. As the terminal device 2A1, a personal computer or a workstation may be used.

The terminal system 2B also includes a terminal device 2B1, a display 2B2 and a video camera 2B3 similarly to the terminal system 2A. The video camera 2B3 takes images of faces of the attendants from the company Y. The display 2B2 produces images and voices of the attendants from the company X. The terminal device 2B1 performs transmission and reception of the image and voice data of the both sides.

In this way, the terminal system 2A and the terminal system 2B transmit the image and voice data of the attendants from the company X and the image and voice data of the attendants from the company Y to each other. Hereinafter, image data that are transmitted from the terminal system 2A are referred to as “image data 5MA”, and voice data of the same are referred to as “voice data 5SA”. In addition, image data that are transmitted from the terminal system 2B are referred to as “image data 5MB”, and voice data of the same are referred to as “voice data 5SB”.

In order to transmit and receive these image data and voice data in real time, the teleconference system 100 utilizes a streaming technique based on the code or the recommendation concerning a visual telephone or a video conference that was laid down by an organization of ITU-T (International Telecommunication Union-Telecommunication Standardization Sector), for example. Therefore, the conference support system 1, the terminal system 2A and the terminal system 2B are equipped with hardware and software for transmitting and receiving data in accordance with the streaming technique. In addition, as a communication protocol for the network 4, RTP (Real-time Transport Protocol) or RTCP (Real-time Transport Control Protocol) that was laid down by ITU-T may be used.

The conference support system 1 includes a CPU 1a, a RAM 1b, a ROM 1c, a magnetic storage device 1d, a display 1e, an input device 1f such as a mouse or a keyboard, and various interfaces as shown in FIG. 2.

Programs and data are installed in the magnetic storage device 1d for realizing functions that include a data reception portion 101, a text data generation portion 102, an emotion distinguishing portion 103, a topic distinguishing portion 104, a record generation portion 105, an analysis processing portion 106, a data transmission portion 107, an image compositing portion 108, a voice block processing portion 109 and a database management portion 1DB, as shown in FIG. 3. These programs and data are loaded into the RAM 1b as necessity, and the programs are executed by the CPU 1a. It is possible to realize a part or a whole of the functions shown in FIG. 3 by hardware.

Hereinafter, contents of process in the conference support system 1, the terminal system 2A and the terminal system 2B will be explained in more detail.

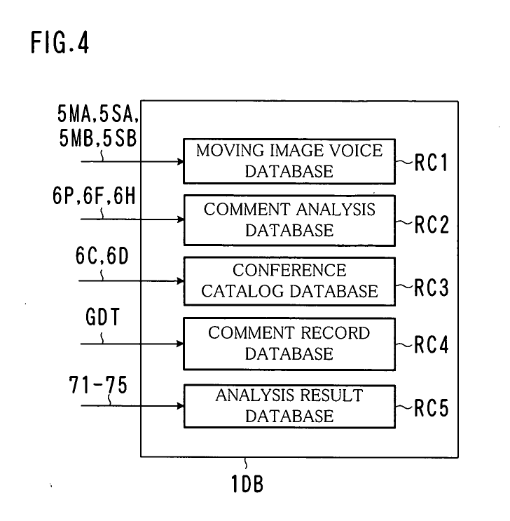

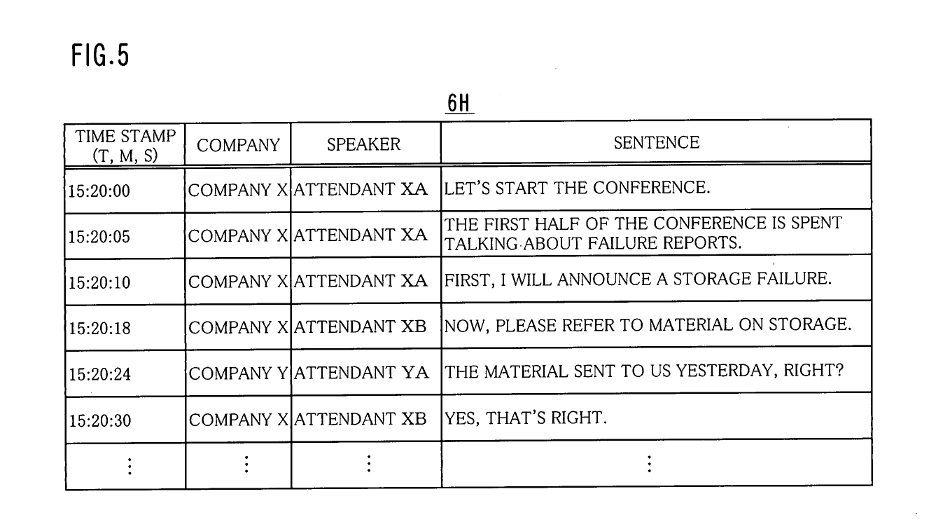

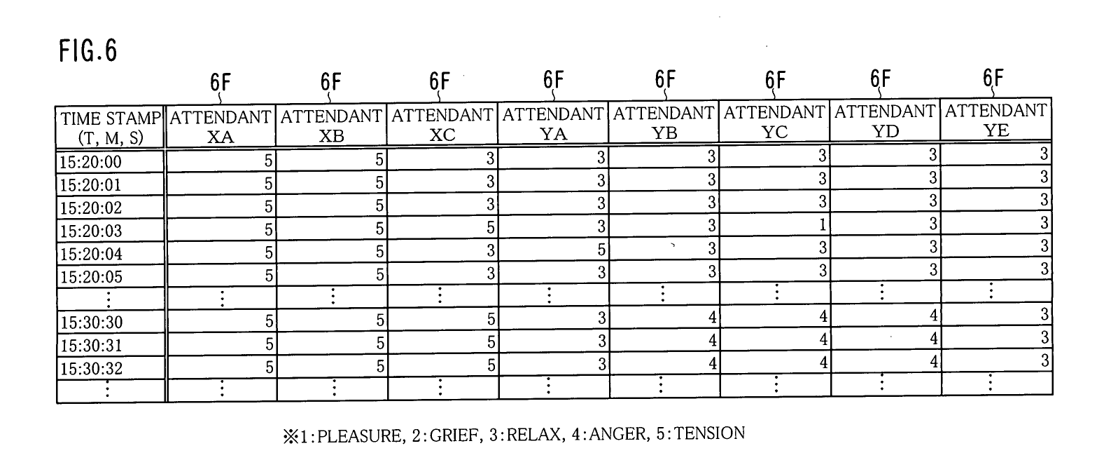

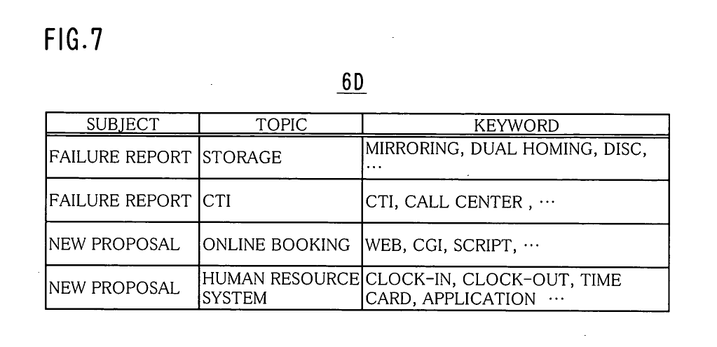

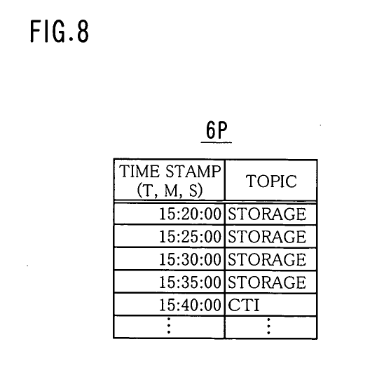

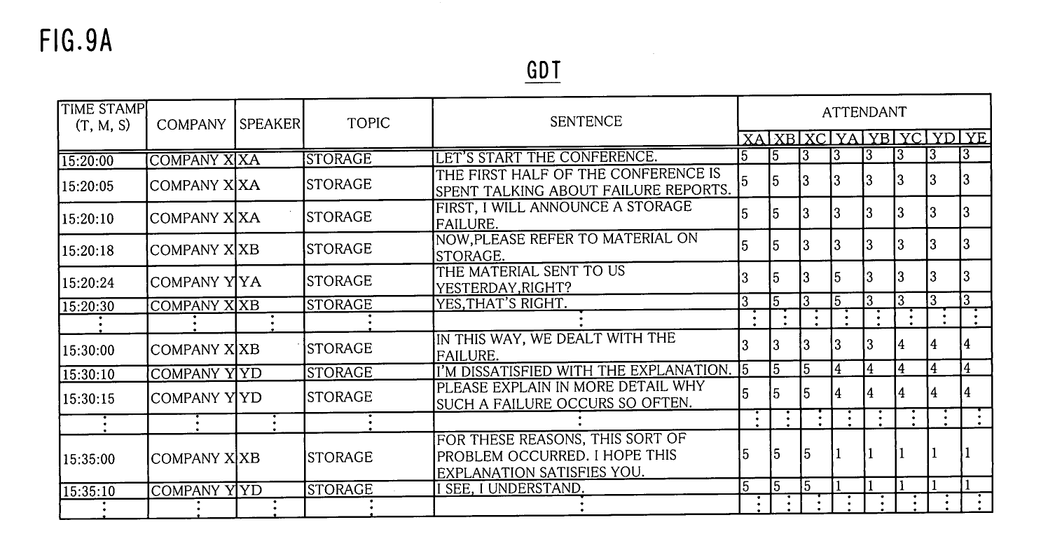

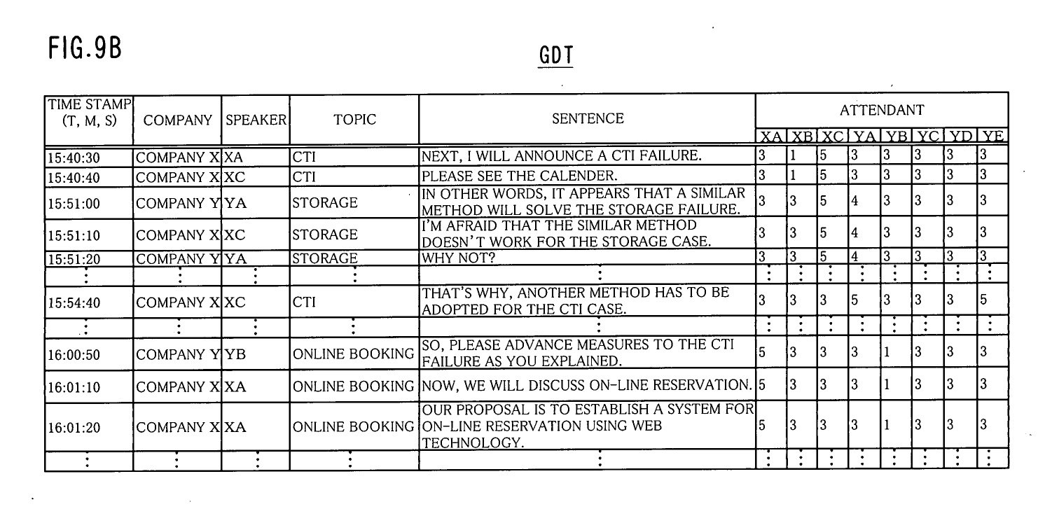

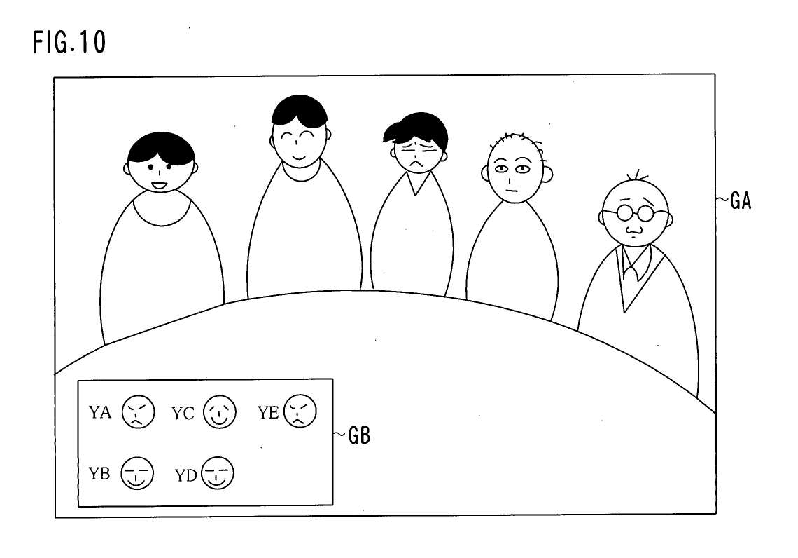

FIG. 4 shows an example of a structure of the database management portion 1DB, FIG. 5 shows an example of comment text data 6H, FIG. 6 shows an example of emotion data 6F, FIG. 7 shows an example of catalog data 6D, FIG. 8 shows an example of topic data 6P, FIGS. 9A and 9B show an example of record data GDT, FIG. 10 shows an example of a display of an image GA showing an appearance on the other end and an emotion image GB, and FIG. 11 shows an example of symbols that are used for the emotion image GB.

The database management portion 1DB shown in FIG. 3 includes databases including a moving image voice database RC1, a comment analysis database RC2, a conference catalog database RC3, a comment record database RC4 and an analysis result database RC5 as shown in FIG. 4 and manages these databases. Contents of the databases will be explained later one by one.

The data reception portion 101 receives the image data 5MA and the voice data 5SA that were delivered by the terminal system 2A and the image data 5MB and the voice data 5SB that were delivered by the terminal system 2B. These received image data and voice data are stored in the moving image voice database RC1 as shown in FIG. 4. Thus, the images and the voices of the conference are recorded.

The text data generation portion 102 generates comment text data 6H that indicate contents of comments made by the attendants from the company X and the company Y as shown in FIG. 5 in accordance with the received voice data 5SA and 5SB. This generation process is performed as follows, for example.

First, a well-known voice recognition process is performed on the voice data 5SA, which is converted into text data. The text data are divided into sentences. For example, when there is a pause period longer than a predetermined period (one second for example) between speeches, a delimiter is added for making one sentence. In addition, when another speaker starts his or her speech, a delimiter is added for making one sentence.

Each sentence is accompanied with a time when the sentence is spoken. Furthermore, a voice print analysis may be performed for distinguishing a speaker of each sentence. However, it is not necessary to distinguish specifically which member of the attendants is the speaker of the sentence. It is sufficient to determine whether or not a speaker of a sentence is identical to a speaker of another sentence. For example, if there are three attendants from the company X, three types of voice patterns are detected from the voice data 5SA. In this case, three temporary names “attendant XA”, “attendant XB” and “attendant XC” are produced, and speakers of sentences are distinguished by these temporary names.

In parallel with this process, a voice recognition process, a process for combining each sentence with a time stamp, and a process for distinguishing a speaker of each sentence are performed on the voice data 5SB similarly to the case of the voice data 5SA.

Then, results of the processes on the voice data 5SA and 5SB are combined into one and are sorted in the time stamp order. Thus, the comment text data 6H is generated as shown in FIG. 5. The generated comment text data 6H are stored in the comment analysis database RC2 (see FIG. 4).

The emotion distinguishing portion 103 distinguishes emotions of each of the attendants from the company X and the company Y every predetermined time (every one second for example) in accordance with the image data 5MA and 5MB that were received by the data reception portion 101. There are many techniques proposed for distinguishing an emotion of a human in accordance with an image. For example, the method can be used that is described in “Research on a technique for decoding emotion data from a face image on a purpose of welfare usage”, Michio Miyagawa, Telecommunications Advancement Foundation Study Report, No. 17, pp. 274-280, 2002.

According to the method described in the above-mentioned document, an optical flow of a face of each attendant is calculated in accordance with images (frame images) at a certain time and times before and after the time that are included in the image data. Thus, movements of an eye area and a mouth area of each attendant are obtained. Then, emotions including “laughing”, “grief”, “amazement” and “anger” are distinguished in accordance with the movements of them.

Alternatively, a pattern image of a facial expression of each attendant for each emotion such as “laughing” and “anger” is prepared as a template in advance, and a matching process is performed between the face area extracted from the frame image and the template, so as to distinguish the emotion. As a method for extracting the face area, the optical flow method as described in the above-mentioned document as well as another method can be used that is described in “Recognition of facial expressions while speaking by using a thermal image”, Fumitaka Ikezoe, Ko Reikin, Toyohisa Tanijiri, Yasunari Yoshitomi, Human Interface Society Papers, Jun. 6, 2004, pp. 19-27. In addition, another method can be used in which heat on a tip of a nose of an attendant is detected, and the detection result is used for distinguishing his or her emotion.

The emotion distinguished results are grouped for each attendant as shown in FIG. 6, which are combined to a time when the frame image that was used for the distinguishing had been taken and stored as the emotion data 6F in the comment analysis database RC2 (see FIG. 4). In this embodiment, five emotions of “pleasure”, “grief”, “relax”, “anger” and “tension” are distinguished. The values “1”-“5” of the emotion data 6F indicate “pleasure”, “grief”, “relax”, “anger” and “tension”, respectively.

However, even if the comment text data 6H (see FIG. 5) and the emotion data 6F of each attendant are obtained by the above-mentioned method, it is not obvious which speaker (attendant) shown in the comment text data 6H corresponds to which emotion data 6F. Therefore, it is necessary that the company X that holds the conference should set the relationship between them after the conference or during the conference.

Alternatively, it is possible to obtain samples of voices and face images of attendants before the conference for making the relationship. For example, a name of each attendant, voice print characteristic data that indicate characteristics of the voiceprint, and face image data for facial expressions (the above-mentioned five types of emotions) are prepared to have relationship with each other in a database. Then, matching process of the received image data 5MA and 5MB and voice data 5SA and 5SB with the prepared face image data or the voice print characteristic data is performed so as to determine the speaker. Thus, the relationship between the speaker indicated in the comment text data 6H and the corresponding emotion data 6F can be known.

Hereinafter, it is supposed that such relationship between the comment text data 6H shown in FIG. 5 and the emotion data 6F shown in FIG. 6 is made (in other words, attendants having the same name in FIGS. 5 and 6 are identical) for explanation.

The conference catalog database RC3 shown in FIG. 4 stores the catalog data 6D as shown in FIG. 7. The catalog data 6D show a list (table of contents) of subjects and topics that are discussed in the conference. In this embodiment, the “subject” means a large theme (a large subject), while the “topic” means particulars or specifics about the theme (small subjects). The “keyword” is a phrase or a word that is related to the topic.

The attendant from the company X makes the catalog data 6D by operating the terminal device 2A1 and registers the catalog data 6D on the conference catalog database RC3 before the conference begins. Alternatively, the catalog data 6D may be registered during the conference or after the conference. However, the catalog data 6D are necessary for a topic distinguishing process that will be explained below, so it is required to be registered before the start of the process.

With reference to FIG. 3 again, the topic distinguishing portion 104 divides the entire period of time for the conference into plural periods having a predetermined length, and for each of the periods (hereinafter referred to as a “predetermined period”) it is distinguished which topic was discussed. This distinguishing process is performed as follows.

For example, first the entire period of time for the conference is divided into plural predetermined periods, each of which has five minutes. All the sentences of speeches that were made during a certain predetermined period are extracted from the comment text data 6H shown in FIG. 5. The number of a topic name included in the extracted sentence and shown in the catalog data 6D is counted for each topic name. Then, the topic having the largest number of the count is distinguished to be the topic that was discussed during the predetermined period. Note that it is possible to distinguish the topic by counting not only the topic names but also phrases indicated in the “keyword”.

In this way, as a result of the distinguishing of the topic during each predetermined period, the topic data 6P shown in FIG. 8 are obtained. Note that the “time stamp” in the topic data 6P means a start time of the predetermined period. The topic data 6P are stored in the comment analysis database RC2 (see FIG. 4).

The record generation portion 105 generates the record of the conference in accordance with the comment text data 6H (see FIG. 5), the emotion data 6F of each attendant (see FIG. 6) and the topic data 6P by the following procedure.

First, an emotion of each attendant is determined for each sentence included in the comment text data 6H. For example, the sentence “Let's start the conference” was spoken during the five-second period that started at 15:20:00. Therefore, the five values indicating emotions during the five seconds are extracted from the emotion data 6F. Among the extracted five values, one having the highest frequency of appearance is selected. For example, “5” is selected for the attendant XA, and “3” is selected for the attendant YC.

The value indicating the emotion of each attendant for each selected sentence, each value (record) of the topic data 6P and each value (record) of the comment text data 6H are combined so that time stamps of them become identical. Thus, the record data GDT as shown in FIGS. 9A and 9B are generated. The generated record data GDT are stored in the comment record database RC4 (see FIG. 4).

The process for generating the record data GDT can be performed after the conference is finished or in parallel with the conference. In the former case, the data transmission portion 107 makes a file of the generated record data GDT, which is delivered to the attendants from the company X and to a predetermined staff (a supervisor of the attendants from the company X for example) by using electronic mail.

In the latter case, the data that are generated sequentially by the record generation portion 105 as the conference proceeds are transmitted to the terminal device 2A1 promptly. In this embodiment, plural record data GDT of five minutes are transmitted one by one because the topic is distinguished for each five-minute period. In addition, a file of complete record data GDT is made after the conference is finished, and the file is delivered to the attendants from the company X and a predetermined staff by means of electronic mail.

Furthermore, the data transmission portion 107 transmits the image data 5MA and the voice data 5SA that were received by the data reception portion 101 to the terminal system 2B, and transmits the image data 5MB and the voice data 5SB to the terminal system 2A. However, the image data 5MB are transmitted after the image compositing portion 108 performed the following process.

The image compositing portion 108 performs a super impose process on the image data 5MB, so as to overlay and composite the image GA obtained by the video camera 2B3 with the emotion image GB that shows the current emotion of the attendant as shown in FIG. 10. In the example shown in FIG. 10, emotions of attendants from the company Y are indicated by symbols. However, it is possible to indicate emotions of attendants from both the company X and the company Y. In addition, the emotion can be indicated by a character string such as “pleasure” or “anger”. It will be explained which symbol of the emotion image GB indicates which emotion with reference to FIG. 11.

Alternatively, instead of the overlaying process by the image compositing portion 108, the image data 5MB and the image data of the emotion image GB may be transmitted, so that the terminal system 2A performs the overlaying process.

Thus, a facilitator of the conference can know promptly that emotions of attendants are going to heat up and can control the emotions of attendants by taking a break for smooth progress of the conference. In addition, responses of the attendants from the company Y toward a proposal made by the company X can be known without delay, so good results of the conference can be obtained more easily than before.

Note that the emotion image GB can be displayed also for the attendants from the company Y although the emotion image GB is displayed only for the company X in this embodiment, which has the purpose (2) mentioned above.

There is a case where a topic for which the discussion was already finished is raised again. This may become an obstacle to smooth progress of the conference. For example, it is understood from the record data GDT shown in FIGS. 9A and 9B that concerning the topic “storage” the discussion was finished once and is raised again around 15:51. In this case, the image compositing portion 108 may perform a process of overlaying a massage “the topic is looping” on the image data 5MB for calling attention.

The terminal systems 2A and 2B deliver images and voices of the party on the other end in accordance with the image data and the voice data that were received from the conference support system 1.

[Analyzing Process After the Conference is Finished]

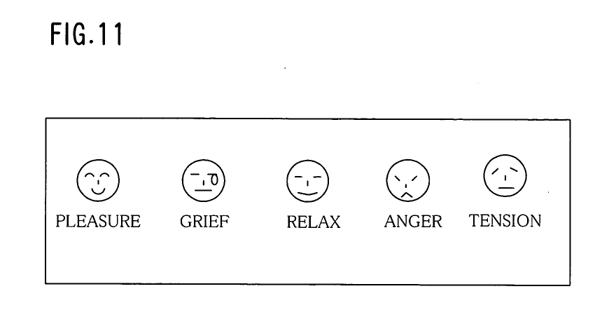

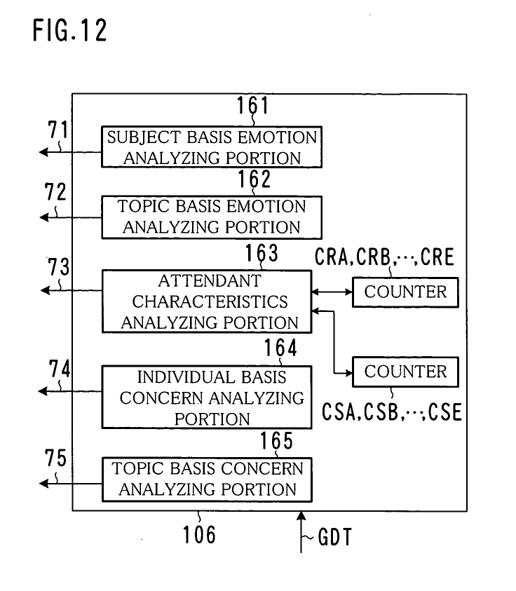

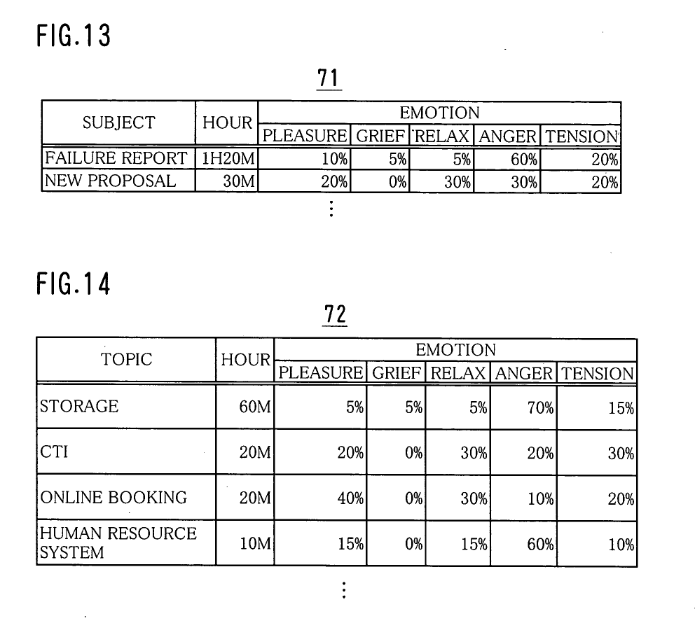

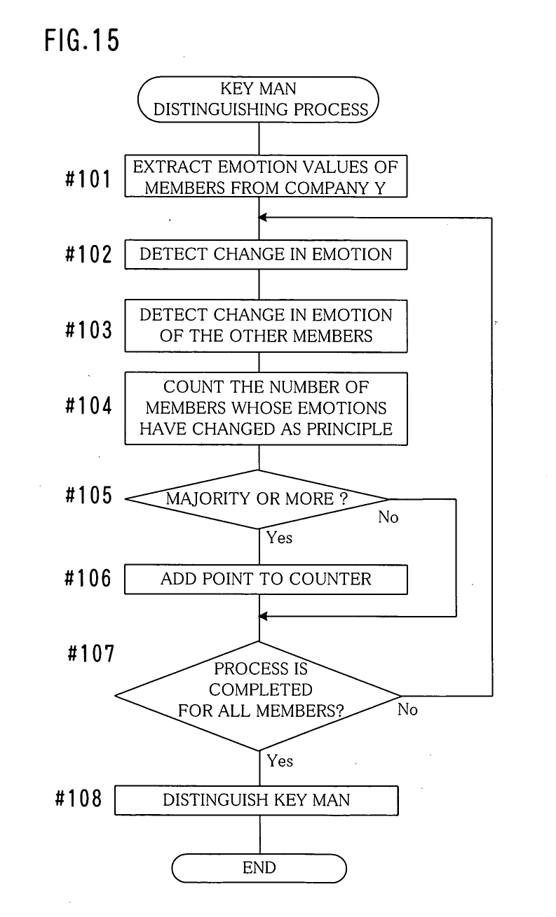

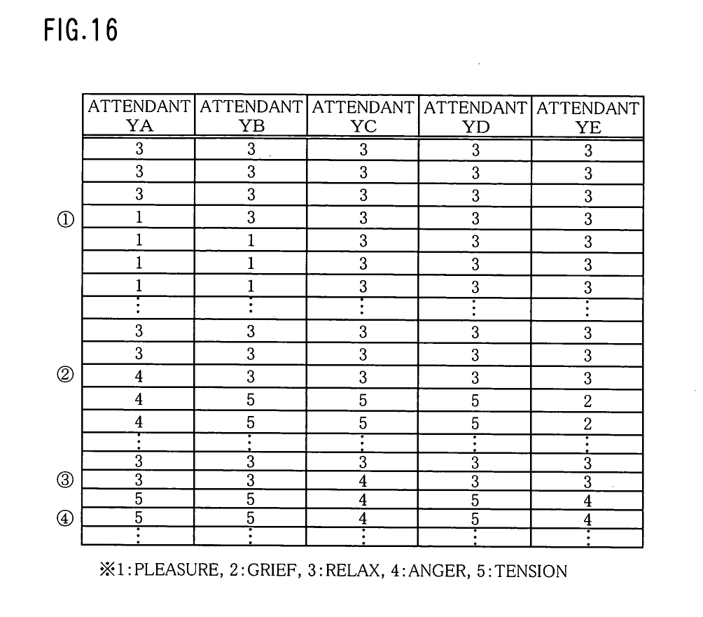

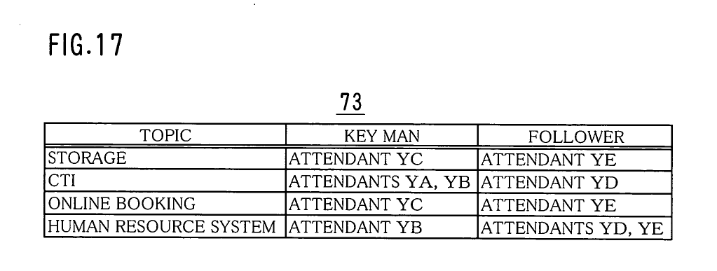

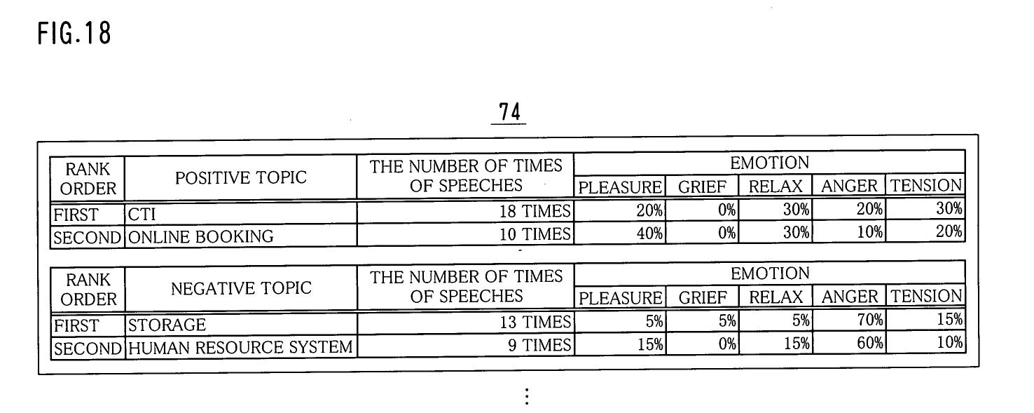

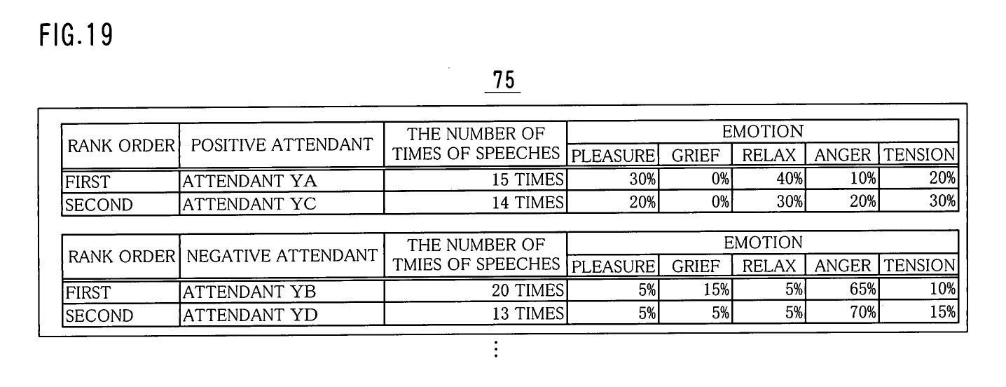

FIG. 12 shows an example of a structure of an analysis processing portion 106, FIG. 13 shows an example of emotion analysis data 71 on subject basis, FIG. 14 shows an example of emotion analysis data 72 on topic basis, FIG. 15 is a flowchart for explaining an example of a key man distinguishing process, FIG. 16 shows changes of emotions of attendants from the company Y during a time period while a certain topic was discussed, FIG. 17 shows an example of characteristics analysis data 73, FIG. 18 shows an example of concern data 74 on an individual basis, and FIG. 19 shows an example of concern data 75 on a topic basis.

The analysis processing portion 106 shown in FIG. 3 includes a subject basis emotion analyzing portion 161, a topic basis emotion analyzing portion 162, an attendant characteristics analyzing portion 163, an individual basis concern analyzing portion 164 and a topic basis concern analyzing portion 165 as shown in FIG. 12. The analysis processing portion 106 performs the analyzing process for obtaining data necessary for achieving the purposes (2) and (3) explained above, in accordance with the record data GDT shown in FIGS. 9A and 9B.

The subject basis emotion analyzing portion 161 aggregates (performs statistical analysis of) times consumed for discussion and emotions of attendants for each subject indicated in the catalog data 6D (see FIG. 7), as shown in FIG. 13. The times consumed for discussion can be obtained by extracting sentence data related to topics that belong to the subject from the record data GDT, calculating speech times of those sentences in accordance with values of “time stamp” and by summing up the speech times.

The emotions of attendants are aggregated by the following process. First, a frequency of appearance is counted for each of the five types of emotions (“pleasure”, “grief” and others) for the attendant that is an object of the process in accordance with the sentence data related to the topic that belongs to the subject and is extracted from the record data GDT. Then, an appearance ratio of each emotion (between the number of appearance times of the emotion and the total number of appearance times of the five types of emotions) is calculated.

As a result of this analyzing process, the subject basis emotion analysis data 71 as shown in FIG. 13 are generated for each attendant. In the same way, it is possible to calculate the subject basis emotion analysis data 71 of the entire of attendants from the company X, the subject basis emotion analysis data 71 of the entire of attendants from the company Y and the subject basis emotion analysis data 71 of the entire of attendants from the company X and the company Y, too. These subject basis emotion analysis data 71 are stored in the analysis result database RC5 (see FIG. 4).

The topic basis emotion analyzing portion 162 aggregates (performs statistical analysis of) times consumed for discussion and emotions of attendants for each subject indicated in the catalog data 6D (see FIG. 7), and obtains topic basis emotion analysis data 72 as shown in FIG. 14. The method of aggregation (statistical analysis) is the same as the case where the subject basis emotion analysis data 71 are obtained, so the explanation thereof is omitted. It is possible to calculate the topic basis emotion analysis data 72 of the entire of attendants from the company X, the topic basis emotion analysis data 72 of the entire of attendants from the company Y and the topic basis emotion analysis data 72 of the entire of attendants from the company X and the company Y, too. These topic basis emotion analysis data 72 are stored in the analysis result database RC5.

The attendant characteristics analyzing portion 163 performs the process for analyzing what characteristics the attendant has. In this embodiment, it analyzes who is the key man (key person) among the attendants from the company Y, as well as who is a follower (yes-man) to the key man, for each topic.

When the emotion of the key man changes, emotions of other members surrounding the key man also change. For example, if the key man becomes relaxed, tensed, delighted or distressed, other members also become relaxed, tensed, delighted or distressed. If the key man gets angry, other members will be tensed. Using this principle, the analysis of the key man is performed in the procedure shown in FIG. 15.

For example, when analyzing the key man of the topic “storage”, emotion values of the attendants from the company Y during the time zone while the discussion about storage is performed, as shown in FIG. 16 (see #101 in FIG. 15).

Concerning the first attendant (attendant YA for example), a change in emotion is detected from the extraction result shown in FIG. 16 (#102). Then, it is understood that the emotion of the attendant YA changes at timings of circled numerals 1-4.

Just after each of them, it is detected how emotions of the other attendants YB-YE have changed (#103), and the number of members whose emotions have changed as the above-explained principle is counted (#104). As a result, if the members whose emotions have changed as the above-explained principle make a majority (Yes in #105), it is assumed there is high probability that the attendant YA be a key man. Therefore, one point is added to the counter CRA of the attendant YA (#106).

For example, in the case of the circled numeral 1, emotion of the attendant YA has changed to “1 (pleasure)”, and emotion of only one of four attendants has changed to “1 (pleasure)” just after that. Therefore, in this case, no point is added to the counter CRA. In the case of the circled numeral 2, emotion of the attendant YA has changed to “4 (anger)”, and emotions of three of four attendants have changed to “5 (tension)”. Therefore, one point is added to the counter CRA. In this way, the value counted by the counter CRA indicates probability of the attendant YA being a key man.

In the same way for the second through the fifth members (attendants YB-YE), the process of steps #102-106 is performed so as to add points to counters CRB-CRE.

When the process of steps #102-106 is completed for all attendants from the company Y (Yes in #107), the counters CRA-CRE are compared with each other, and the attendant who has the counter storing the largest value is decided to be the key man (#108). Alternatively, it is possible there are plural key men. In this case, all the attendants who have counters storing points that exceed a predetermined value or a predetermined ratio may be decided to be the key men.

The emotion of the follower of the key man usually goes with the emotion of the key man. Especially, the follower may be angry together with the key man when the key man becomes angry. Therefore, using this principle, the analysis of the follower is performed as follows.

For example, it is supposed that the key man of the topic “storage” is distinguished to be the attendant YC as the result of the process shown in FIG. 15. In this case, it is detected how emotions of other four attendant YA, YB, YD and YE have changed just after the attendant YC became angry, in accordance with the extracted data shown in FIG. 16. Then, one point is added to the counter of the attendant whose emotion has changed to “4 (anger)”. For example, in the case of the circled numeral 3 emotion of the attendant YC has changed to “4 (anger)”, and only emotion of the attendant YE has changed to “4 (anger)” just after that. Therefore, one point is added to the counter CSE of the attendant YE. No point is added to the counters CSA, CSB and CSD of the attendants YA, YB and YD. Other points where the emotion of the attendant YC has changed to “4 (anger)” are checked, and the adding process of the counter is performed in accordance with changes of emotions of other four attendants.

Then, the counters CSA, CSB, CSD and CSE are compared to each other, and the attendant who has the counter storing the largest value is decided to be the follower. Alternatively, it is possible there are plural followers. In this case, all the attendants who have counters storing points that exceed a predetermined value or a predetermined ratio may be decided to be the followers.

The attendant characteristics analyzing portion 163 analyzes who is the key man and who is the follower among the attendants from the company Y for each topic as explained above. The analysis result is stored as the characteristics analysis data 73 shown in FIG. 17 in the analysis result database RC5 (see FIG. 4).

In general, it is not always true that a person who is in the highest position among the attendants is substantially the key man. In addition, it is possible that the person who is in the highest position is a follower. However, as explained above, the attendant characteristics analyzing portion 163 generates the characteristics analysis data 73 in accordance with influences among the attendants. Therefore, the attendants from the company X can assume a potential key man and a potential follower of the company Y without being confused by a position on the other end or a stereotype of each of the attendants from the company X.

The individual basis concern analyzing portion 164 shown in FIG. 12 performs a process for analyzing which topic an attendant is concerned about. In this embodiment, it is analyzed which topic each attendant from the company Y has good concern (positive concern or feedback) about and which topic each attendant from the company Y has bad concern (negative concern or feedback) as follows.

In accordance with the topic basis emotion analysis data 72 (see FIG. 14) of the attendant who is an object of the analysis, positive (good) topics and negative (bad) topics for the attendant are distinguished. For example, if the ratio of “pleasure” and “relax” is more than a predetermined ratio (50% for example), it is distinguished to be a positive topic. If the ratio of “anger” and “grief” is more than a predetermined ratio (50% for example), it is distinguished to be a negative topic. For example, if the topic basis emotion analysis data 72 of the attendant YA have contents as shown in FIG. 14, it is distinguished that “storage” and “human resource system” are negative topics while “CTI” and “online booking” are positive topics for the attendant YA.

The number of times of speeches made by the attendant to be analyzed about the positive topic is counted in accordance with the record data GDT (see FIGS. 9A and 9B). Then, it is decided that a topic of larger number of times of speeches is a topic of higher positive concern. In the same way, the number of times of speeches is also counted for negative topics, and it is decided that a topic of larger number of times of speeches is a topic of higher negative concern. In this way, the individual basis concern data 74 as shown in FIG. 18 are obtained for each attendant from the company Y.

The topic basis concern analyzing portion 165 analyzes who has the most positive (the best) concern and who has the most negative (the worst) concern among the attendants for each topic. In this embodiment, the analysis is performed for the attendants from the company Y.

For example, when analyzing the topic “storage”, attendants who have emotions of “pleasure” or “relax” at more than a predetermined ratio in the time zone while the topic “storage” was discussed are distinguished in accordance with the topic basis emotion analysis data 72 (see FIG. 14) of each attendant. The number of times of speeches made by the attendant about the topic “storage” is counted in accordance with the record data GDT (see FIGS. 9A and 9B). Then, it is decided that an attendant having more number of times of speech has higher positive concern.

In the same way, attendants who have emotions of “anger” or “grief” at more than a predetermined ratio in the time zone while the topic. “storage” was discussed are distinguished, and it is decided that an attendant having more number of times of speech about the topic “storage” among the attendants has higher negative concern.

In this way, the topic basis concern data 75 as shown in FIG. 19 are obtained for each topic.

As explained above, the record generation portion 105 and the analysis processing portion 106 perform the process for generating data that include the record data GDT, the subject basis emotion analysis data 71, the topic basis emotion analysis data 72, the characteristics analysis data 73, the individual basis concern data 74 and the topic basis concern data 75.

The attendants from the company X and the related person can study variously about the conference this time in accordance with these data like whether or not the purpose of the conference is achieved, what is the topic discussed most, how may hours are consumed for each topic, which topic gained a good response or a bad response from the company Y, whether or not there was inefficient portion such as repeated loops of the same topic, and who is the attendant having a substantial decisive power (a key man). Then, it is possible to prepare for the next conference about each topic like how to carry the conference, who should be a target of speech, and what is the topic to be discussed with great care (the critical topic).

[Effective Process in the Second and Later Conference]

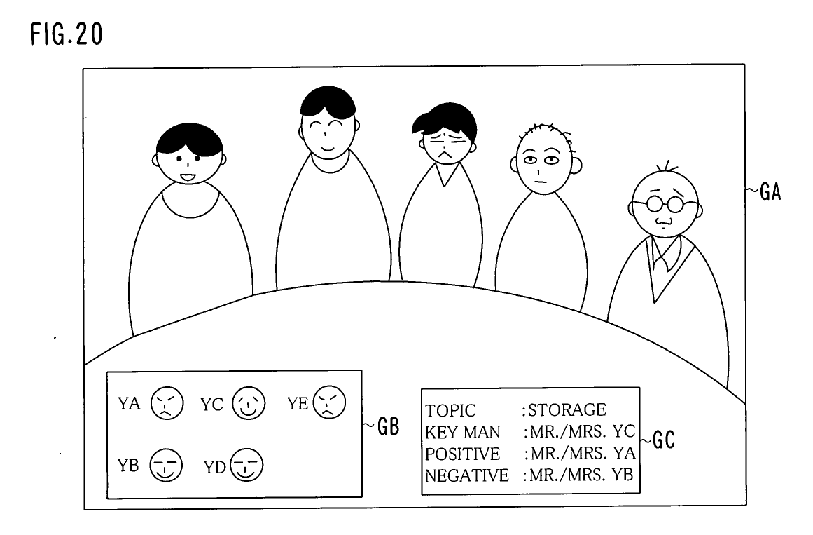

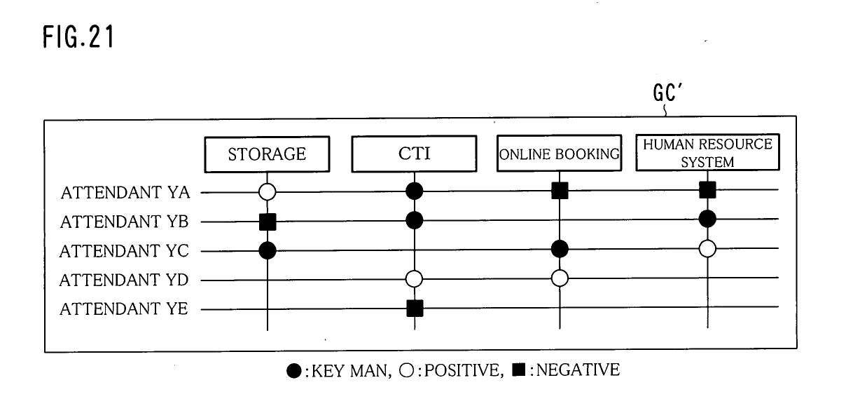

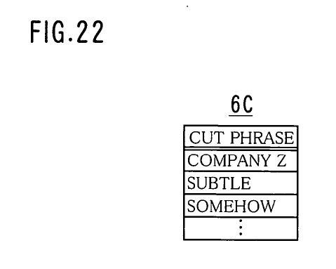

FIG. 20 shows an example of a display by overlaying an emotion image GB and an individual characteristics image GC on an image GA that shows the appearance on the other end, FIG. 21 shows an example of an individual characteristics matrix GC′, and FIG. 22 shows an example of cut phrase data 6C. Next, a particularly effective process in the second and later conference will be explained.

The image compositing portion 108 shown in FIG. 3 performs the following process during the conference, i.e., the process of overlaying information (data) on the image of the attendants from the company Y responding to a request from the attendant from the company X. The information (data), which includes the record data GDT and the subject basis emotion analysis data 71 through the topic basis concern data 75 of the conference that was held before, is stored in the comment record database RC4 and the analysis result database RC5.

For example, when receiving a request for display of a key man of the topic “storage”, an attendant who has the highest positive idea (concern) and an attendant who has the highest negative idea (concern), the process is performed for overlaying the individual characteristics image GC on the image GA as shown in FIG. 20.

Alternatively, it is possible to overlap the individual characteristics matrix GC′ in which key men, positive persons and negative persons of plural topics are gathered as shown in FIG. 21 on the image GA, instead of the individual characteristics image GC shown in FIG. 20. If there are many attendants, it is possible to indicate a few (three for example) attendants as each of the attendants having high positive concern and attendants having high negative concern in the individual characteristics matrix GC′. Note that dots, circles and black boxes represent key men, positive attendants and negative attendants, respectively.

In this way, the individual characteristics image GC or the individual characteristics matrix GC′ is displayed, so that the attendants from the company X can take measures for each of the attendants from the company Y. For example, it is possible to explain individually to an attendant who has a negative idea after the conference is finished, so that he or she can understand the opinion or the argument of the company X. In addition, it can be assumed easily how the idea of the attendant has changed from that in the previous conference by comparing the emotion image GB with the individual characteristics image GC.

The voice block processing portion 109 performs the process of eliminating predetermined words and phrases from the voice data 5SA for the purpose (3) explained before (to cut speeches that will be offensive to the attendants from the company Y). This process is performed in the following procedure.

An attendant from the company X prepares the cut phrase data 6C that are a list of phrases to be eliminated as shown in FIG. 22. The cut phrase data 6C may be generated automatically in accordance with the analysis result of previous conferences. For example, the cut phrase data 6C may be generated so as to include topics about which all the attendants from the company Y had negative concern or topics about which the key man had negative concern. Alternatively, the attendant from the company X may add names of competitors of the company Y, names of persons who are not harmony with the company Y and ambiguous words such as “somehow” to the cut phrase data 6C by operating the terminal device 2A1.

The voice block processing portion 109 checks whether or not a phrase indicated in the cut phrase data 6C is included in the received voice data 5SA by the data reception portion 101. If the phrase is included, the voice data 5SA are edited to eliminate the phrase. The data transmission portion 107 transmits the edited voice data 5SA to the terminal system 2B in the company Y.

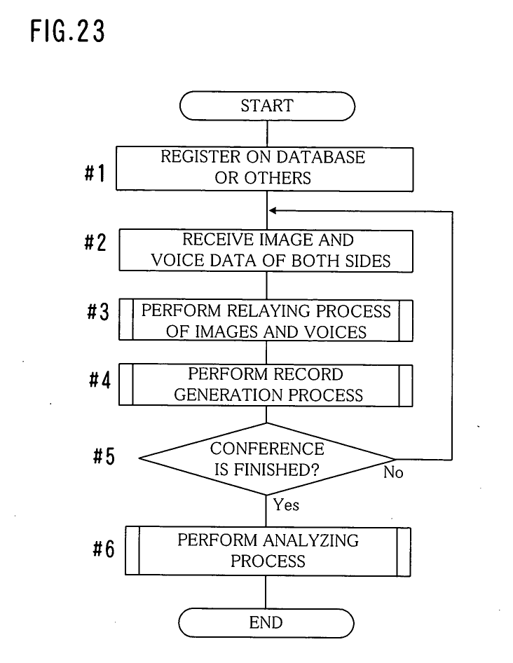

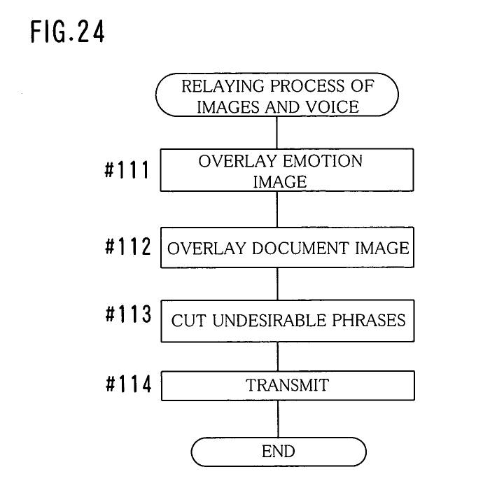

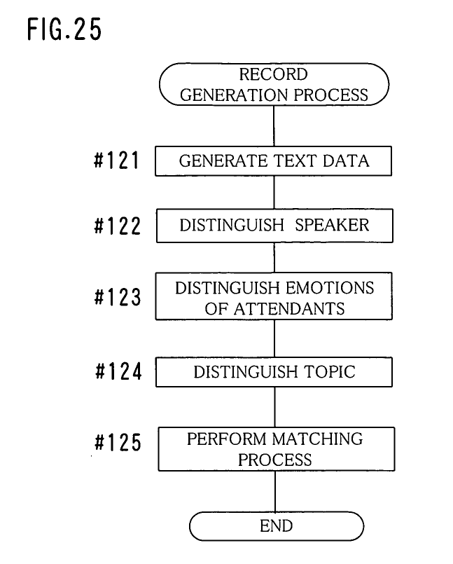

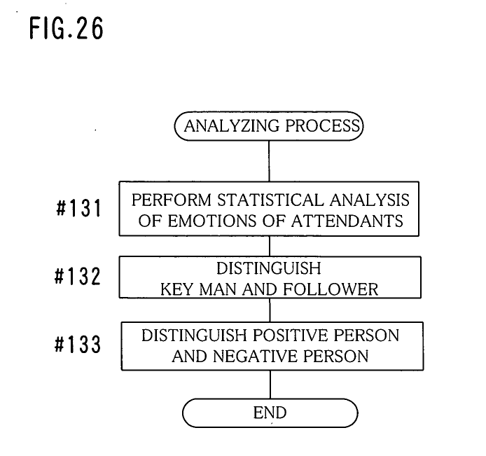

FIG. 23 is a flowchart showing an example of a general process of the conference support system 1, FIG. 24 is a flowchart for explaining an example of a relaying process of images and voices, FIG. 25 is a flowchart for explaining an example of a record generation process, and FIG. 26 is a flowchart for explaining an example of an analyzing process.

Next, a process of the conference support system 1 for relaying between the terminal system 2A and the terminal system 2B will be explained with reference to the flowcharts.

In FIG. 23, an attendant from the company X prepares the catalog data 6D as shown in FIG. 7 and the cut phrase data 6C as shown in FIG. 22 so as to register them on the conference catalog database RC3 shown in FIG. 4 before the conference starts (#1). Note that if the process for generating the comment record is performed after the conference, it is possible to register the catalog data 6D after the conference.

When the conference starts, image and voice data of both sides are transmitted from the terminal systems 2A and 2B. The conference support system 1 receives these data (#2), and performs the process for transmitting image and voice data of the company X to the company Y and for transmitting image and voice data of the company Y to the company X (#3). In addition, in parallel with the process of step #3, the process for generating the record is performed (#4). The process of step #3 is performed in the procedure as shown in FIG. 24.

As shown in FIG. 20, the process for overlaying the emotion image GB that indicates emotions of attendants from the company Y on the image of the company Y (the image GA) is performed (#111 in FIG. 24). The emotions of attendants from the company Y are obtained by the process of step #4 that is performed in parallel (see FIG. 25). Furthermore, responding to the request from the attendants from the company X, data of documents that were obtained in the previous conference are overlaid on the image GA (#112). For example, as shown in FIGS. 20 and 21, the individual characteristics image GC or the individual characteristics matrix GC′ is overlaid.

In parallel with the process of steps #111 and #112, phrases that will be offensive to the attendants from the company Y are eliminated from the voice of the company X (#113). Then, the image and voice data of the company X after these processes are transmitted to the terminal system 2B of the company Y, while the image and voice data of the company Y are transmitted to the terminal system 2A of the company X (#114).

The process of step #4 shown in FIG. 23 is performed in the procedure as shown in FIG. 25. Speeches of the attendants from the company X and the company Y are converted into text data in accordance with the voice data of the company X and the company Y, respectively (#121 in FIG. 25). In parallel with this, speakers of sentences are distinguished (#122), and emotions of the attendants from the company X and the company Y are distinguished in accordance with the image data (face image) of the company X and the company Y, respectively (#123). The entire time of the conference is divided-into plural time periods (predetermined periods) having a predetermined length (five minutes for example). Then, it is distinguished which topic the contents of discussion relate to (#124).

Matching process of generated text data, the distinguished result of the speakers and the distinguished result of emotions of the attendants is performed so as to generate the record data GDT shown in FIGS. 9A and 9B sequentially (#125). Note that the process for generating the record data GDT can be performed after the conference is finished. However, it is necessary to overlay the emotion image GB in step #111 shown in FIG. 24, so the process (#124) for distinguishing emotions of the attendants from the company X and the company Y is required to be performed in real time with carrying the conference.

With reference to FIG. 23 again, while the image and voice data are transmitted from the terminal systems 2A and 2B (No in #5), the process of steps #2-4 is repeated.

After the conference is finished and the record data GDT are completed (Yes in #5), the analyzing process about the attendants from the company Y is performed in accordance with the record data GDT (#6). Namely, as shown in FIG. 26, the statistical analysis of emotions of the attendants is performed for each topic or subject (#131), a key man and a follower are distinguished for each topic (#132), and an attendant having high positive concern and an attendant having high negative concern are distinguished for each topic (#133). As a result, the subject basis emotion analysis data 71, the topic basis emotion analysis data 72, the characteristics analysis data 73, the individual basis concern data 74 and the topic basis concern data 75 (see FIGS. 13, 14, 17, 18 and 19) are generated.

According to this embodiment, the record is generated automatically by the conference support system 1. Therefore, the attendant who is a recorder is not required to write during the conference, so he or she can concentrate on joining the discussion. The conference support system 1 analyzes the record and distinguishes a key man, an attendant having positive concern or feedback and an attendant having negative concern or feedback for each topic. Thus, the facilitator of the conference can readily consider how to carry the conference or take measures for each attendant. For example, he or she can explain the topic that the key man dislikes on another day.

The teleconference system 100 can be used for not only a conference, a meeting or a business discussion with a customer but also a conference in the company. In this case, it can be known easily which topic the company employees have concern about, who is a potential key man, or between whom there is a conflict of opinions. Thus, the teleconference system 100 can be used suitably for selecting members of a project.

Though one emotion of each attendant is determined for each speech in this embodiment, it is possible to determine a plurality of emotions of each attendant during the speech so that a variation of the emotion can be detected. For example, it is possible to determine and record emotions at plural time points including the start point, a middle point and the end point of the speech.

In this embodiment, the image data and the voice data that are received from the terminal systems 2A and 2B are transmitted to the terminal systems 2B and 2A on the other end after performing the process such as the image composition or the phrase cut. Namely, the conference support system 1 performs the process for relaying the image data and the voice data in this embodiment. However, in the following case, the terminal systems 2A and 2B can receive and transmit the image data and the voice data directly without the conference support system 1.

If the process for eliminating offensive phrases is not performed by the voice block processing portion 109 shown in FIG. 3, the terminal systems 2A and 2B transmit the voice data to the conference support system 1 and the terminal systems 2B and 2A on the other end. The conference support system 1 uses the voice data received from the terminal systems 2A and 2B only for generating the record data GDT and various analyses. The data transmission portion 107 does not perform the transmission (relay) of the voice data to the terminal systems 2A and 2B. Instead, the terminal systems 2A and 2B delivers voices of attendants in accordance with the voice data that are transmitted directly from the terminal systems 2B and 2A on the other end.

Similarly in the case where the process for compositing (overlaying) an image as shown in FIG. 10 or 20 is not necessary, or the process is performed by the terminal systems 2A and 2B, the terminal systems 2A and 2B transmit the image data to the conference support system 1 and the terminal systems 2B and 2A on the other end. The conference support system 1 uses the image data that were received from the terminal systems 2A and 2B only for generating the record data GDT and various analyses. The data transmission portion 107 does not perform the transmission (relay) of the image data to the terminal systems 2A and 2B but transmits the image data such as the emotion image GB, the individual characteristics image GC or the individual characteristics matrix GC′ (see FIG. 21), as necessity. Instead, the terminal systems 2A and 2B display appearances of attendants in accordance with the image data that are directly transmitted from the terminal systems 2B and 2A on the other end.

Though five types of emotions are distinguished as shown in FIG. 11 in this embodiment, it is possible to distinguish other emotions such as “sleepy” or “bored”. In addition, it is possible to perform the analyzing process in accordance with an appearance ratio of the emotion such as “sleepy” or “bored”.

The conference support system 1 shown in FIG. 1 may be made of a plurality of server machines. For example, the conference support system 1 may include an image voice storage server, a natural language process server, an emotion recognition process server, a streaming server and an analysis server, and the processes shown in FIG. 3 may be performed by these servers in a distributed processing manner.

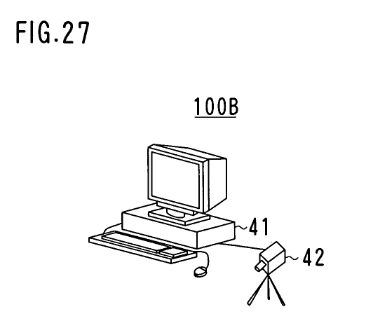

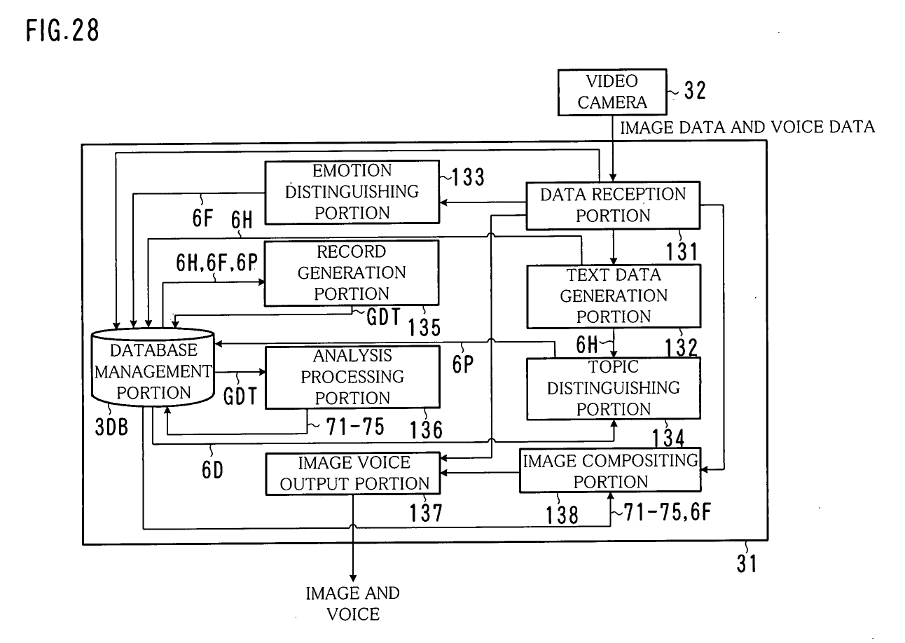

FIG. 27 shows an example of an overall structure of a conference system 100B, and FIG. 28 shows a functional structure of a terminal device 31.

In this embodiment, an example is explained where staff members of the company X and the company Y join a conference from sites that are remote to each other. However, the present invention can be applied to the case where they gather at one site for joining a conference. In this case, the conference system 100B may be constituted as follows.

The conference system 100B includes a terminal device 31 such as a personal computer or a workstation and a video camera 32 as shown in FIG. 27. The video camera 32 takes pictures of faces of all attendants in a conference. In addition, the video camera 32 is equipped with a microphone for collecting voices of speeches made by the attendants.

Programs and data are installed in the terminal device 31 for constituting functions that include a data reception portion 131, a text data generation portion 132, an emotion distinguishing portion 133, a topic distinguishing portion 134, a record generation portion 135, an analysis processing portion 136, an image voice output portion 137, an image compositing portion 138 and a database management portion 3DB as shown in FIG. 28.

The data reception portion 131 receives image and voice data that show the conference from the video camera 32. The text data generation portion 132 through the analysis processing portion 136, the image compositing portion 138 and the database management portion 3DB perform the same processes as the text data generation portion 102 through the analysis processing portion 106, the image compositing portion 108 and the database management portion 1DB that were explained above with reference to FIG. 3.

The image voice output portion 137 displays a synthetic image (image GA) of the emotion image GB and the individual characteristics image GC or the individual characteristics matrix GC′ (see FIGS. 20 and 21) on the display device. If the conference room is wide, speakers may be used for producing voices. In addition, it is possible to produce a voice for calling attention in the case where emotions of attendants more than a predetermined number become “anger” or a topic is repeatedly discussed (looped).

Moreover, structures of a part or a whole of the teleconference system 100, the conference system 100B, the conference support system 1, the terminal system 2A and the terminal system 2B, the contents of processes, the order of processes and others can be modified in the scope of the present invention.

The present invention can be used suitably by a service provider such as ASP (Application Service Provider) for providing a conference relay service to an organization such as a company, an office or a school. In order to provide the service, the service provider opens the conference support system 1 shown in FIG. 1 on a network. Alternatively, it is possible to provide the conference system 100B shown in FIG. 27 to a customer as a stand-alone type system.

While the presently preferred embodiments of the present invention have been shown and described, it will be understood that the present invention is not limited thereto, and that various changes and modifications may be made by those skilled in the art without departing from the scope of the invention as set forth in the appended claims.

1. A conference support system comprising:
an image input portion for entering images of faces of attendants at a conference;
an emotion distinguishing portion for distinguishing emotion of each of the attendants in accordance with the entered images;
a voice input portion for entering voices of the attendants;
a text data generation portion for generating text data that indicate contents of speech made by the attendants in accordance with the entered voices; and
a record generation portion for generating a record that includes the contents of speech and the emotion of each of the attendants when the speech was made in accordance with a distinguished result made by the emotion distinguishing portion and the text data generated by the text data generation portion.

2. The conference support system according to claim 1, wherein the emotion distinguishing portion distinguishes the emotion in accordance with one or more images that were obtained during a time period while the speech was being made.

3. The conference support system according to claim 1, wherein the emotion distinguishing portion distinguishes the emotion in accordance with the image that was obtained at a time point when the speech was started.

4. The conference support system according to claim 1, further comprising
a subject information storage portion for storing one or more subjects to be discussed in the conference, and
a subject distinguishing portion for deciding which subject the speech relates to in accordance with the subject information and the text data, wherein
the record generation portion generates a record that includes the subject to which the speech relates in accordance with a distinguished result made by the subject distinguishing portion.

5. The conference support system according to claim 4, further comprising a concern distinguishing portion for deciding which subject the attendants are concerned with in accordance with the record.

6. The conference support system according to claim 5, wherein the concern distinguishing portion decides which subject the attendants are concerned with in accordance with statistic of emotions of the attendants when the speech was made for each subject.

7. The conference support system according to claim 4, further comprising a concern degree distinguishing portion for deciding who is most concerned with the subject among the attendants in accordance with the record.

8. The conference support system according to claim 7, wherein the concern degree distinguishing portion decides who is most concerned with the subject among the attendants in accordance with statistic of emotions of the attendants when the speech about the subject was made.

9. The conference support system according to claim 4, further comprising a key person distinguishing portion for deciding a key person of the subject in accordance with the record.

10. The conference support system according to claim 9, wherein the key person distinguishing portion decides the key person of the subject in accordance with emotions of the attendants except for a person who made the speech right after the speech about the subject was made.

11. The conference support system according to claim 9, further comprising a follower distinguishing portion for distinguishing a person who follows the key person of the subject in accordance with emotions of the attendants except for a person who made the speech right after the speech about the subject was made.

12. The conference support system according to claim 1, further comprising
a phrase list storage portion for storing a list of phrases that will be offensive to the attendants,
a phrase erasing portion for performing an erasing process in which a phrase that is included in the list is erased from the voice that was entered by the voice input portion, and
a voice output portion for producing data of the voice after the erasing process was performed by the phrase erasing portion.

13. The conference support system according to claim 12, wherein the list is generated in accordance with the distinguished result made by the emotion distinguishing portion.

14. The conference support system according to claim 1, further comprising
an image compositing portion for compositing the image that was entered by the image input portion with an image that indicates a distinguished result made by the emotion distinguishing portion, and
an image output portion for producing data of the image that was composited by the image compositing portion.

15. A teleconference support system for relaying a conference among a plurality of sites that are remote from each other, the system comprising:
an image input portion for entering images of faces of attendants at a conference from each of the sites;
an emotion distinguishing portion for distinguishing emotion of each of the attendants in accordance with the entered images;
a voice input portion for entering voices of the attendants;
a text data generation portion for generating text data that indicate contents of speech made by the attendants in accordance with the entered voices; and
a record generation portion for generating a record that includes the contents of speech and the emotion of each of the attendants when the speech was made in accordance with a distinguished result made by the emotion distinguishing portion and the text data generated by the text data generation portion.

16. A method for generating a record of a conference, comprising the steps of:
entering images of faces of attendants at a conference;
performing an emotion distinguishing process for distinguishing emotion of each of the attendants in accordance with the entered images;
entering voices of the attendants;
generating text data that indicate contents of speech made by the attendants in accordance with the entered voices; and
generating a record that includes the contents of speech and the emotion of each of the attendants when the speech was made in accordance with a result made of the emotion distinguishing process and the text data.

17. A computer program product for use in a computer that generates a record of a conference, the computer program product comprising:
means for entering images of faces of attendants at the conference;
means for performing an emotion distinguishing process for distinguishing emotion of each of the attendants in accordance with the entered images;
means for entering voices of the attendants;
means for generating text data that indicate contents of speech made by the attendants in accordance with the entered voices; and
means for generating a record that includes the contents of speech and the emotion of each of the attendants when the speech was made in accordance with a result made of the emotion distinguishing process and the text data.
